(19) United States
(12) Patent Application Publication
(10) Pub. No.: US 2003/0026673 A1
(43) Pub. Date: Feb. 6, 2003

(54) Connection device

(76) Inventor: Horst Filipp, (US)

Correspondence Address: Attn: Maurice E. Gauthier, Samuels, Gauthier & Stevens LLP, Suite 3300, 225 Franklin Street, Boston, MA, 02110, US

(21) Appl. No.: 10/194,102

(22) Filed: Jul. 12, 2002

(30) Foreign Application Priority Data
Jul. 14, 2001 (DE) 10134375.2

(51) Int. Cl. F16B 13/06

(52) U.S. Cl. 411/44

(57) ABSTRACT

A connection device including an expander sleeve (1) which has slots (10) extending axially over a partial region, and an expander cone (3) which is introduced in the region of the slots (10) into the expander sleeve (1), is designed so that the expander cone (3) is connected by a form-fit or friction-fit connection to the expander sleeve (1) before the connection device is mounted.

The present invention relates to a connection device according to the preamble of claim 1.

Connection devices of this type have many applications.

They are used, for example, to attach hardware such as door handles or window handles to hollow shapes.

To make the attachment, a screw is rotated into an expander cone, thereby pulling the expander cone into the expander sleeve while simultaneously spreading the tabs formed by the slots.

Spreading of the tabs creates a secure connection of the expander sleeve with the fastening component, on the one hand, and through the screw with the mounting component, on the other.

There are problems, however, with mounting the connection device which arise from the fact that the expander cone is retained on the expander sleeve only by the screw, and is therefore easily lost.

This factor not only makes assembly more difficult but can also result in the expander sleeve and expander cone becoming lost in the event the connection must be broken. In this case, the parts mentioned fall into the hollow cavity where at a minimum they cannot easily be retrieved, and in most cases not at all.

The goal of the invention is therefore to design a connection device according to the species in such a way that simplifies its handling, especially assembly, while facilitating its reuse.

This goal is achieved by a connection device having the features of claim 1.

Due to the permanent retention of the expander cone in the expander sleeve, the connection device may be readily inserted into a hole provided for it in the fastening component. In a preferred embodiment of the connection device, the mantle side of the end section of the expander sleeve opposite the expander cone contacts the interior diameter of the hole, this section of the expander sleeve being provided, in a preferred embodiment of the invention, with a knurling or analogous roughening by which the expander sleeve is held secure against rotation to the fastening component either by a form-fit and/or a friction-fit interface.

The form-fit interface between the expander cone and the expander sleeve may, for example, consist of a band which forms a section of the cylindrical shoulder, and is provided on the side opposite a conical end section of the expander cone, and engages an undercut of the expander sleeve, thereby providing a unilateral anti-slip lock before the connection device is mounted.

When the expander cone is pulled into the expander sleeve by rotating the screw, while the tabs spread apart as described above, this shoulder moves up to the region of the expander sleeve where the latter contacts the interior hole diameter of the fastening component.

To achieve a friction-fit connection between the expander cone and the expander sleeve, the outside diameter of the cylindrical shoulder of the expander cone and the inside diameter of the expander sleeve are designed as a press-fit interface, at least in the area of mutual contact. This ensures that the expander sleeve and the expander cone are permanently connected before insertion of the connection device.

It is appropriate in this regard, especially in view of the fact that these connection devices are mass-produced items, to have the expander cone pressed into the expander sleeve by machine.

In analogous fashion, the band may also be dimensioned to achieve a friction fit which prevents it from turning along with the screw when the screw is rotated into the expander cone.

In addition, the knurled section of the expander sleeve is pressed into the inside of the hole by the band so that the expander sleeve, as well as the expander cone, are securely retained within the fastening component after removal of the screw. The result is that, subsequently, a new screw may be rotated in without altering the position and effectiveness of the connection device.

This feature provides, of course, an essential simplification of assembly, but also an improvement in efficiency since the need to use a new connection device is eliminated.

In an advantageous modification of the invention, the expander sleeve has on its end face opposite the expander cone, or the expander cone has on its end face opposite the expander sleeve, an extremely flat collar slightly larger than the hole of the fastening component. When the connection device is inserted this collar forms a stop, and thus a mounting aid, since the collar rests in the end position on the surface of the fastening component.

The outer dimension of the band of the expander cone is only slightly larger than the inside diameter of the section of the expander sleeve forming the undercut so that the tabs of the expander sleeve are only slightly expanded during the pre-assembly process of pressing in the expander cone. The intrinsic elastic forces of the tabs ensure that the tabs return to their original position once the expander cone has been pressed in.

Additional advantageous embodiments of the invention are identified in the subclaims.

Certain embodiments of the invention are described below based on the attached drawings.

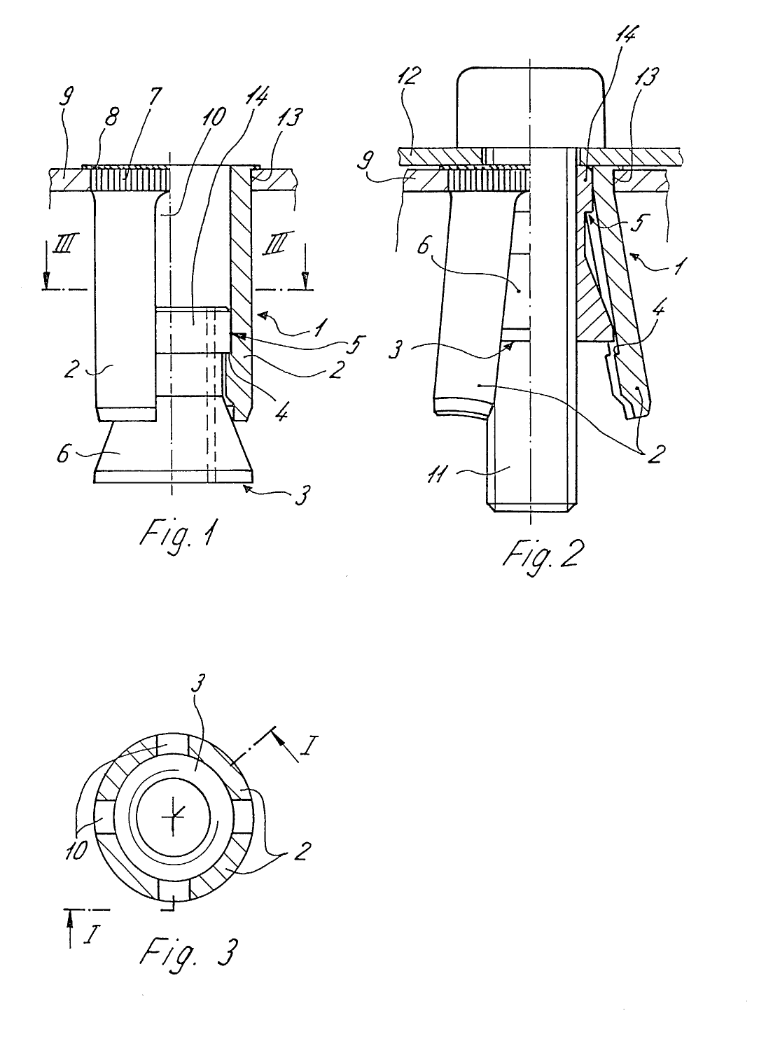

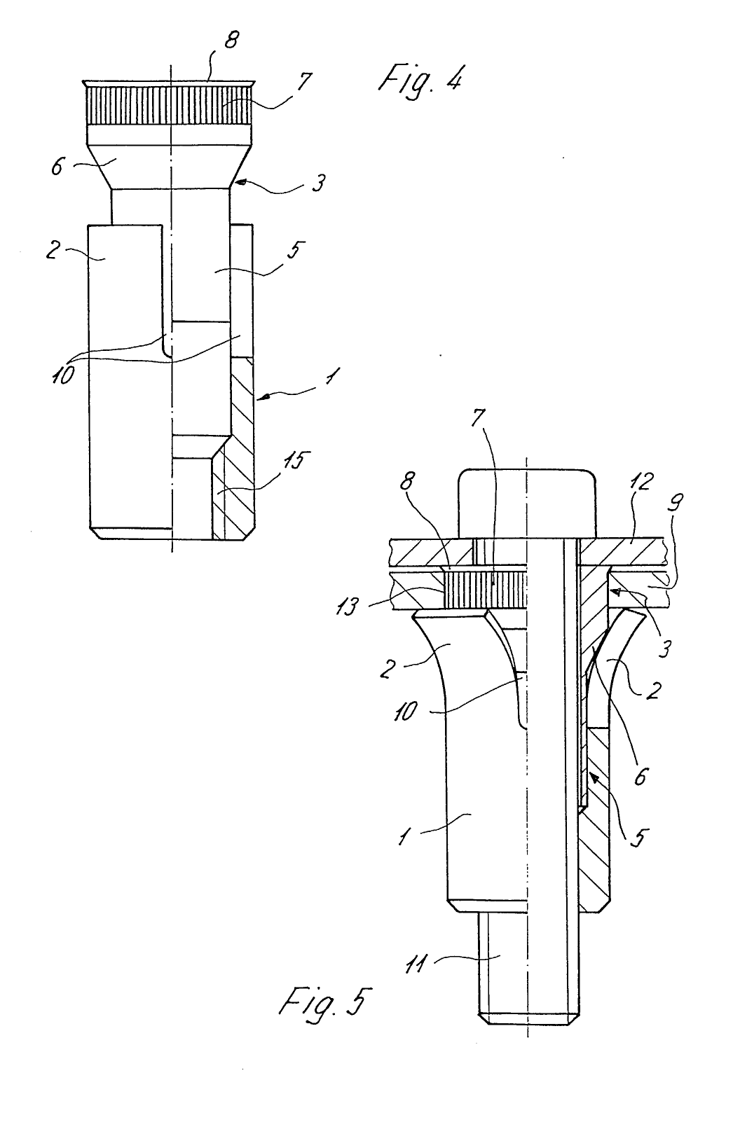

FIG. 1 shows a partial lengthwise section through a connection device in the undeployed position as indicated by line I-I in FIG. 3.

FIG. 2 shows the connection device in the deployed position, also as a partial lengthwise section.

FIG. 3 shows a cross-section through the connection device as indicated by line III-III in FIG. 1.

FIG. 4 shows a partial lengthwise section of another embodiment of the connection device before installation.

FIG. 5 shows the connection device of FIG. 4 in the mounted position, also as a partial lengthwise section.

The figures show a connection device which has an expander sleeve 1 and an expander cone 3.

Starting from one end of expander sleeve 1, multiple slots 10 extending longitudinally are provided through which the tabs 2 are formed which in turn are expanded by expander cone 3 in the deployed position of the connection device as shown in FIG. 2.

In the embodiment shown in FIGS. 1 through 3, a screw 11 is rotated into expander cone 3, expander cone 3 of course having an interior thread.

As FIG. 1 very clearly shows, expander cone 3 has a cylindrical shoulder 5 with a band 14 on its end opposite a conical component 6, the band engaging an undercut 4 of expander sleeve 5¹, and the undercut being formed by an inside diameter which is otherwise smaller than the inside hole of expander sleeve 2². Undercut 4 is provided in the end section facing expander cone 3. ¹Translator's note: erroneous in original, should read “1”. ² Translator's note: erroneous in original, should read “1”.

The outside diameter of band 14 is dimensioned to create a press-fit interface together with the associated inside hole of expander sleeve 1.

Expander sleeve 1 has a collar 8 on its end face opposite expander cone 3, by which collar expander sleeve 1 abuts a fastening component 9. The following cylindrical section of expander sleeve 1 is provided with a circumferential knurling 7 which abuts the inside diameter of hole 13 through which the connection device is inserted. The inside diameter of hole 13 and the outside diameter of expander sleeve 1 are appropriately matched to provide a friction fit.

In FIG. 2, an attachment component 12 is connected to a fastening component 9. It is evident here that expander cone 3 is pulled by screw 11 up to an extreme end position in which a portion of band 14 overlaps the knurling 7.

Tabs 2 are expanded to such an extent by conical component 6 of expander cone 3 that any axial displacement of expander sleeve 1 is precluded, thus ensuring a secure connection of attachment component 12 to fastening component 9.

By dimensionally matching band 14 with the associated inside diameter of expander sleeve 1 which, as mentioned, provides a press fit, expander cone 3 is secured against rotation within expander sleeve 1. In addition, as expander cone 3 is tightened, band 14 ensures that the knurled section 7 presses against the inside diameter of hole 13.

The position of expander sleeve 1 and of expander cone 3 reached in FIG. 2 thus remains unchanged even when screw 1 is unscrewed and replaced. This feature allows attachment component 12 to be readily detached as necessary without the need for employing a new connection device.

In the embodiment of a connection device shown in FIGS. 4 and 5, cylindrical shoulder 5 of expander cone 3, which extends as a smooth shaft from one end to conical component 6, is pressed into the interior hole of expander sleeve 1.

An interior thread 15 follows this interior hole, into which thread screw 11 may be screwed, expander sleeve 1 being drawn during the mounting process of the connection device through said hole in the direction of fastening component 9, while tabs 2 are expanded which abut conical component 6 of expander cone 3 inserted into fastening component 9.

In the final position shown in FIG. 5, the tabs rest by their leading edges against fastening component 9, while cylindrical shoulder 5 projects into a region of expander sleeve 1 which lies outside slots 10 such that the friction-fit connection between expander cone 3 and expander sleeve 1 remains in place in this region.

Even when screw 11 is removed, expander sleeve 1 remains fixed to expander cone 3. Knurling 7 on the end section opposite cylindrical shoulder 5 creates a form-fit interface between fastening component 9 and expander cone 1, as a result of which the connection device as a whole remains fixed, during said removal of the screw, in its original position and is thus available without restriction for repeated use.

List of References

| | |
|---|---|
| 1 | expander sleeve |
| 2 | tab |
| 3 | expander cone |
| 4 | undercut |
| 5 | shoulder |
| 6 | conical component |
| 7 | knurling |
| 8 | collar |
| 9 | fastening component |
| 10 | slot |
| 11 | screw |
| 12 | attachment component |
| 13 | hole |

1. Connection device including an expander sleeve (1) which has slots (10) extending axially over a partial region, and an expander cone (3) which is introduced in the region of the slots (10) into the expander sleeve (11)³ and is connected by a form-fit or friction-fit connection to the expander sleeve (1) before the connection device is mounted, characterized in that the expander cone (3) has a cylindrical shoulder (5), the diameter of which is at least partially so designed, and the inside diameter of the associated inner hole of the expander sleeve (1) is so designed, that they form a press-fit interface.
³ Translator's note: erroneous in original, should read “1”.

2. Connection device according to claim 1, characterized in that the shoulder (5) is designed in part as a band (14) which engages an undercut (4) of the expander sleeve (1).

3. Connection device according to claims 1 or 2, characterized in that the diameter of the band (14) and the inside diameter of the associated inner hole of the expander sleeve (1) are designed to create a press-fit interface.

4. Connection device according to claim 1, characterized in that the cylindrical end section of the expander sleeve (1) opposite the expander cone (3), or the end section of the expander cone (3) facing away from the expander sleeve (1), is provided with knurling (7).

5. Connection device according to claim 1, characterized in that the end face of the expander sleeve (1) opposite the expander cone (3), or the end face of the expander cone (3) facing away from the expander sleeve (1), is provided with a circumferential collar (8).

6. Connection device according to claim 4, characterized in that the outside diameter of the expander sleeve (1) in the region of the knurling (7), and the diameter of the hole (13) of a fastening component (9) into which the connection device may be inserted, are dimensioned to create a press-fit interface.

7. Connection device according to claim 5, characterized in that the free end face of the collar (8) is provided with a knurling.

8. Connection device according to claim 1, characterized in that the length of the cylindrical shoulder (5) is greater than the length of the slots (10).

9. Connection device according to claim 2, characterized in that the outside diameter of the band (14) [is] slightly greater that the smallest inside diameter of the hole forming the undercut (4).
